(19) United States
(12) Patent Application Publication
(10) Pub. No.: US 2005/0255225 A1
(43) Pub. Date: Nov. 17, 2005

(54) Meat extract and process for producing the same

(75) Inventors: Akihito Fujimoto, Tsuchiura-shi (JP); Kenji Torii, Inashiki-gun (JP); Makoto Watanabe, Tsuchiura-shi (JP); Takahisa Miyamoto, Fukuoka-shi (JP)

Correspondence Address: DARBY & DARBY P.C., P. O. BOX 5257, NEW YORK, NY, 10150-5257, US

(73) Assignee: Kyowa Hakko Food Specialties Co., Ltd., Chiyoda-ku (JP)

(21) Appl. No.: 11/128,859

(22) Filed: May 13, 2005

(30) Foreign Application Priority Data
May 14, 2004 (JP) 2004-144961

(51) Int. Cl. A23L 1/31

(52) U.S. Cl. 426/655

(57) ABSTRACT

A meat extract is provided such that it contains no detectable microorganisms other than spore-forming bacteria and includes 60 mmol/l or more of phosphate ion, preferably 60 to 500 mmol/l, more preferably 70 to 500 mmol/l, and even more preferably 70 to 200 mmol/l. Also a process for producing a meat extract is provided. The process includes obtaining a liquid extract from a material containing muscle tissues or bone tissues of livestock; adjusting the phosphate ion concentration of the liquid extract to 60 mmol/I or more; and then sterilizing at ultra-high temperature (UHT sterilization).

### INCORPORATION BY REFERENCE

The present application claims priority under 35 U.S.C. §119 to Japanese Patent Application No. 2004-144961 filed on May 14, 2004. The content of the application is incorporated herein by reference in its entirety.

### BACKGROUND OF THE INVENTION

The present invention relates to a meat extract and process for producing the same.

Various methods are known for sterilizing liquid food or drink such as meat extracts, beverages and the like, and the simplest method is heat treatments. Retort sterilization is known as one of the heat sterilization treatment but it may cause deterioration of food quality such as cooked odor, volatilization of flavor and the like.

The ultra-high-temperature sterilization (hereinafter, referred to as UHT sterilization) is known to be a heating treatment that can minimize the bad effect of heating.

However, spore-forming bacteria, which are heat resistant microorganisms, may survive the UHT sterilization for low-acid liquid food or drink or neutral liquid food or drink. Examples of such microorganisms include those which belong to the genus Bacillus, Sporolactobacillus, Clostridium, Sporosarcina and the like. When such microorganisms remain, they grow in the food or drink and cause deterioration of the food or drink such as generating of putrid smell, increasing of viscosity, turbidity and the like.

One of the methods known to control the growth of the spore-forming bacteria is to add ethanol, acetic acid and fish extract to noodle sauce to enhance the bacteriostatic effect (Japanese Published Unexamined Patent Application No. 259832/2003), but the use of food additives, such as ethanol, acetic acid and the like, sometimes causes unfavorable effects on the flavor of food or drink.

A method known to enhance preservation of food or drink without sterilization and additives is to increase the soluble solid content of a meat extract by condensation (Boukin Boubai Vol. 31, No. 9, p. 479-484). However, there is a problem in that the flavor of the meat extract with a high soluble solid content is not so good.

### OBJECT AND SUMMARY OF THE INVENTION

The object of the present invention is to provide a meat extract with good preservability and a process for producing the same.

The present invention relates to the following (1) to (13):

(1) A meat extract in which no microorganisms other than spore-forming bacteria are detectable and 60 mmol/l or more of phosphate ion is contained.

(2) A meat extract according to the above (1), wherein the spore-forming bacteria are selected from a group consisting of microorganisms belonging to the genus Bacillus, Sporolactobacillus, Clostridium and Sporosarcina.

(3) A meat extract according to the above (1) wherein the microorganism belonging to the genus Bacillus is a microorganism belonging to Bacillus stearothermophilus.

(4) A meat extract according to the above (1) wherein the meat extract is a meat extract extracted from materials comprising muscle tissues or bone tissues of livestock.

(5) A meat extract according to the above (4) wherein the livestock is poultry.

(6) A process for producing a meat extract comprising:
preparing a liquid extract from a material comprising muscle tissues or bone tissues of livestock;
adjusting the phosphate ion concentration of the liquid extract to 60 mmol/l or more; and then sterilizing at ultra-high temperature (UHT sterilization).

(7) A process for producing a meat extract comprising:
preparing a liquid extract from a material comprising muscle tissues or bone tissues of livestock;
sterilizing the liquid extract by UHT sterilization; and then
adjusting the phosphate ion concentration of the liquid extract to 60 mmol/l or more.

(8) A process for producing a meat extract according to the above (6), wherein the material comprising muscle tissues or bone tissues contains 150 parts by weight or less of bone tissues to 100 parts by weight of muscle tissues.

(9) A process according to the above (6), wherein the UHT sterilization is conducted at 120 to 130° C.

(10) A process according to the above (6), wherein the UHT sterilization is conducted for 5 to 15 seconds.

(11) A process according to the above (6), wherein the livestock is poultry.

(12) A method of suppressing the growth of spore-forming bacteria in a meat extract comprising:
adjusting a phosphate ion concentration in the meat extract extracted from a material comprising muscle tissues and bone tissues of livestock to 60 mmol/l or more.

(13) A method according to the above (12), wherein the livestock is poultry.

The present invention provides a meat extract with good flavor and preservability, a process for producing the same and a method of inhibiting the growth of spore-forming bacteria in the meat extract.

The above, and other objects, features and advantages of the present invention will become apparent from the following description read in conjunction with the accompanying drawings, in which like reference numerals designate the same elements.

### DETAILED DESCRIPTION OF THE PREFERRED EMBODIMENTS

The meat extract of the present invention can be any meat extract that contains no detectable microorganisms other than spore-forming bacteria and includes 60 mmol/l or more of phosphate ion, preferably 60 to 500 mmol/l, more preferably 70 to 500 mmol/l, and even more preferably 70 to 200 mmol/l.

Examples of the spore-forming bacteria include, microorganisms belonging to the genus Bacillus, Sporolactobacillus, Clostridium and Sporosarcina. Examples of bacteria belonging to the genus Bacillus include Bacillus stearothermophilus, Bacillus brevis, Bacillus cereus, Bacillus licheniformis, Bacillus circulans, and Bacillus subtilis.

Examples of microorganisms other than spore-forming bacteria include microorganism belonging to the genus Pseudomonas, Alcaligenes, Enterobacter, Brevibacterium, Micrococcus and Staphylococcus.

Microorganisms in the meat extract of the present invention can be detected by the method according to Food Hygiene Test Guideline I, Individual Test Method (edited by the Ministry of Health and Welfare, Department of Environmental Hygiene. Published by the Japan Food Hygiene Association on Nov. 15, 1973, ppl 03-106) as described below.

One ml of the meat extract of the present invention is put in a plastic petri dish aseptically, and 20 ml of nutrient agar medium (manufactured by Nissui Pharmaceutical Co.), which has been sterilized, melted and kept at 47° C. is added thereto. The Petri dish is rotated gently and the medium is solidified by cooling. The petri dish is incubated at 50° C. for 5 days and examined whether any colonies can be detected in the agar medium.

If no colony is detected, it is determined that there is no detectable microorganism.

When colonies are detected, it is possible to determine whether the microorganisms forming the colonies are spore-forming bacteria or not by the method described below, described in Food Hygiene Test Guideline I, Individual Test Method (Edited by the Ministry of Health and Welfare, Department of Environmental Hygiene. Published by the Japan Food Hygiene Association on Nov. 15, 1973, p 106).

All the colonies detected in this test are collected, and each of them are suspended into 1 ml of sterilized water in 1.5 ml-sample tube, respectively. If there are many colonies, 1 ml of sterilized water is added to the agar medium and the cells forming the colonies are suspended with a spreader to prepare cell suspension.

A tube containing the cell suspension is heated in a boiling water bath for 10 minutes and centrifuged at 3000 G for 10 minutes to precipitate cells. After removing the supernatant, the cells are re-suspended in 1 ml of sterilized water, heated in a boiling water bath for 10 minutes and then centrifuged at 3000 G for 10 minutes to precipitate cells. After removing the supernatant, a spore suspension is obtained by suspending the precipitated cells in 1 ml of sterilized water. The spore suspension (0.1 ml) is inoculated to nutrient agar medium and incubated at 50° C. for 48 hours. If colonies are observed, it is determined that the microorganisms forming the colonies are spore-forming bacteria.

The concentration of phosphate ion in a meat extract can be measured by the capillary electrophoresis method or the high-speed liquid chromatography method. In the capillary electrophoresis method, the measurement can be conducted, for example, by using a capillary electrophoresis apparatus (HEWLETT PACKARD 3D CE, manufactured by Agilent Technologies) using Fusedsilica (50 μm×104 cm, total length, 112.5 cm) as the capillary and Agilent Plating Bath Buffer as a buffer, at capillary temperature of 15° C., with a negative voltage of 30 kV, at a measuring wave length of 350.20 nm (reference 230.10 nm).

The process for producing the meat extract of the present invention is described below.

The meat extract of the present invention can be prepared by extracting a meat extract from a material comprising the muscle or bone tissues of livestock animals, adjusting the concentration of phosphate ion in the extract to the concentration described above, and preferably sterilizing it.

Any material that comprises muscle or bone tissues of one or more types of livestock animals may be used as the material for the present invention. The total weight of the muscle or bone tissues is 50 percent by weight or more of the material, preferably 80 percent by weight or more, even more preferably 90 percent by weight or more, and yet more preferably 95 percent by weight or more. Especially preferred material for use consists of the muscle or bone tissues of livestock animals.

Examples of material comprising the muscle or bone tissues of livestock animals include: split carcasses obtained by splitting a carcass with a saw or the like after slaughtering a livestock animal (hereinafter, referred to as dressed carcass), dressed meat, bones with meat still attached, which are obtained as byproducts when preparing dressed meat from a dressed carcass (hereinafter, referred to as bone carcass) and the like. If necessary, a mixture thereof may be used as the material.

For 100 parts by weight of the muscle tissue, it would be preferable for the bone content to be 150 parts by weight or less, more preferably 50 parts by weight or less, and even more preferably no bone content, i.e., only muscle content (dressed meat).

The livestock animals to be used here may be any of the domesticated animals, preferably poultry, pigs, cattle and the like. Among them, poultry are used more preferably.

Examples of the poultry include chickens, wild ducks, ostriches, ducks, turkeys and the like, and chickens may be used preferably.

If the material is poultry, examples of the dressed meat include breasts, thigh, white meat and the like. If the material is pork, shoulder, shoulder lion, loin, fillet, rib, thigh, outer thigh and the like can be used. If the material is cattle, shoulder, shoulder loin, rib loin, sirloin, fillet, rib, thigh, outer thigh, rump and the like can be used.

Examples of the bone carcass include bone carcass of poultry, pork, beef and the like.

The extraction from the material is preferably conducted using an extraction medium under conditions that allow the extraction of organic acids, inorganic acids, and especially phosphate ion which are present in the muscle tissue.

Examples of the extraction media include aqueous medium, organic solvents and the like, but aqueous medium is used preferably.

As an aqueous medium, water is used preferably but aqueous solutions comprising inorganic salts, ethanol and the like may be used, if necessary. Examples of the inorganic salts include sodium chloride, potassium chloride, calcium chloride and the like. Examples of the organic solvent include ethanol and the like.

The amount of extraction medium to be used may be determined appropriately depending on the material and extraction methods. For example, to 100 parts by weight of material, generally 50 to 1000 parts by weight of the extraction medium, or preferably 100 to 300 parts by weight of the extraction medium may be used.

The temperature at the extraction is not particularly limited so long as the meat extract, preferably meat extract containing phosphate ion, can be extracted from the material, preferably at 65 to 135° C., more preferably at 70 to 121° C. and even more preferably at 90 to 100° C.

The extracting time is not particularly limited so long as the meat extract, preferably the meat extract containing phosphate ion, can be extracted from the material, preferably 2 to 24 hours, more preferably 4 to 12 hours and even more preferably 8 to 12 hours.

Any apparatus may be used so long as it is possible to extract the meat extract, preferably the meat extract containing phosphate ion from the material. For example, a heating apparatus such as an atmospheric cooker, a pressure cooker, a hot kneader and the like may be used.

After the extracting process, a liquid extract may be prepared by removing insoluble solid materials, if needed. Methods of removing insoluble solid materials include a conventional method of solid-liquid separation such as; sedimentation separation including standing method or centrifuging method; cake filtration method; clarifying filtration method; or centrifugal filtration method.

The liquid extract may contain fat which is produced at the extraction step. It is preferable to separate and remove the fat at the solid-liquid separation step by using a three-layer separator or the like.

The liquid extract may be obtained from the material comprising the muscle and bone tissues of livestock animals and the like by the procedures described above. If necessary, the liquid extract may be a mixture of two or more of the liquid extracts, for example, a mixture of the liquid extracts from bone carcass and dressed meat may be used.

After the extraction process, the phosphate ion concentration in the obtained liquid extract is adjusted, if necessary, to 60 mmol/l or more, preferably to 60 to 500 mmol/l, more preferably to 70 to 500 mmol/l and even more preferably to 70 to 200 mmol/l. The phosphate ion concentration may be adjusted by concentrating the liquid extract or by adding phosphoric acid or phosphate salt to the liquid extract. However, concentrating the liquid extract is preferable.

The method of concentrating the liquid extract include heating method, reverse osmosis method, reduced pressure method, freeze drying method, or the like. The concentration ratio is not restricted in particular but when the concentration ratio rises, so does the viscosity of the extract liquid, causing worsening of the workability. Solid component content in the concentrated liquid extract is preferably 50 percent by weight of the total weight or less and more preferably 20 percent by weight or less.

The solid components content may be measured by a commercially available Brix scale, such as an ATAGO hand held refractometer (manufactured by ATAGO Co. Ltd.) and the like.

If the liquid extract is not concentrated, or if the phosphate ion concentration does not reach the value described above even after the concentration, the phosphate ion concentration may be adjusted, for example, by adding phosphoric acid or phosphate salt to the liquid extract.

When mixing two or more kinds of the liquid extracts, the concentration of phosphate ion contained in the liquid extracts is adjusted separately and the liquid extracts may be mixed each other until the phosphate ion is 60 mmol/l or more, or preferably 60 to 500 mmol/l, more preferably 70 to 500 mmol/l, or even more preferably 70 to 200 mmol/l. The phosphate ion concentration in the liquid extract after mixing may be adjusted by modifying the mixing ratio of the liquid extracts or by adding phosphate salt or phosphoric acid, but it is preferable to modify the mixing ratio. For example, the concentrated liquid extract obtained from bone carcass, in which the phosphate concentration is not adjusted, and the liquid extract obtained from dressed meat, in which the phosphate ion concentration is adjusted by concentration, may be mixed so that the concentration of phosphate ion in the mixture is as described above.

The timing of the adjustment of the phosphate ion concentration in the liquid extract is not particularly limited but it is preferable to adjust it before the sterilization step.

As the phosphate salts to be added, any phosphate salts may be used so long as it dissolves in the liquid extract and dissociates phosphate ions. The phosphate salts include, sodium dihydrogen phosphate, potassium dihydrogen phosphate, disodium hydrogen phosphate, dipotassium hydrogen phosphate, trisodium phosphate, or tripotassium phosphate.

The liquid extract with adjusted phosphate ion concentration, prepared by the method described above may be used as it is as the meat extract of the present invention if no microorganisms other than spore-forming bacteria are detected. However, the meat extract of the present invention is obtained usually after the sterilization step or the like described below.

As a sterilization method, any method, including UHT sterilization, retort sterilization, HTST sterilization or the like, may be used as long as microorganisms other than spore-forming bacteria can be sterilized. The method which causes less deterioration of flavor and shows high sterilization efficiency such as the UHT sterilization method and the like may be preferred.

The conditions for the UHT sterilization method may be chosen appropriately depending on the nature of the solid components and the types of the meat extract as well as the species and the numbers of microorganisms in the meat extract. The sterilization is carried out generally at 120 to 150° C., preferably at 120 to 130° C. and more preferably at 120 to 125° C. The sterilization time is normally for 5 to 60 seconds, preferably for 5 to 15 seconds and more preferably for 5 to 10 seconds.

UHT sterilization may be carried out by direct heating or indirect heating. Examples of the direct heating methods include the steam injection method by which high pressure steam is directly injected into the meat extract or food or drink, the steam infusion method by which the meat extract or food or drink are injected into high pressure steam, the Joule heating method by which electric current is applied to the meat extract or food or drink or the like. Examples of the indirect heating method include the method using a plate heat exchanger, a tube heat exchanger, scraped-surface heat exchanger or the like.

Examples of the apparatus for the UHT sterilization include “Asepliser” SDI type (for sterilization by direct heating with steam, Izumi Food Machinery Co.), Joule Heating Sterilization System FJL series (for Joule heating method, Frontier Engineering Co.), “Asepliser” PHX type (for plate-type indirect heating sterilization, Izumi Food Machinery Co.), “Asepliser” SHE type (for scraped-surface indirect heating sterilization Izumi Food Machinery Co.), “Asepliser” THX type (for tube-type indirect heating sterilization, Izumi Food Machinery Co.), Small Volume Liquid Continuous Sterilization Test Machine RMS type (Hisaka Works Co. Ltd.) and the like.

The meat extract of the present invention may contain, if necessary, various additives that may be used for food or drink, such as organic acids, amino acids, nucleic acids, sugars and the like. The timing of the addition of these additives is not specified but it is preferable to add them before the sterilization step. When additives are added after the sterilization step, it is preferable to add them aseptically.

Examples of the organic acids include propionic acid, lactic acid, acetic acid, formic acid, citric acid, tartaric acid, maleic acid, oxalic acid, succinic acid, malic acid and the like.

Examples of the amino acids include sodium glutamate, glycine and the like.

Examples of the nucleic acids include sodium inosinate, sodium guanylate and the like.

Examples of the sugars include sucrose, glucose, lactose and the like.

Generally, the meat extract of the present invention may be packaged in a container aseptically after the sterilization. Examples of the containers include an aluminum pouch, a PET (polyethylene terephthalate) bottle, a Cartocan (paper beverage can), a “Bag-in-Box” container and the like. The method of packaging the meat extract in a container aseptically after sterilization may be any method so long as no microorganisms except spore-forming bacteria are detected when presence or absence of the microorganisms in a meat extract packaged in this method are checked according to the above mentioned method. After the sterilization step, if microorganisms other than spore-forming bacteria are detected, the sterilization is carried out again

The meat extract of the present invention may be added to food or drink, or used as it is as a soup by diluting with hot water and, if necessary, adding salt or the like. The food or drink, to which the meat extract of the present invention is added, includes, for example, soups such as Japanese style clear soup, consomme soup, egg soup, wakame sea weed soup, shark fin soup, potage, miso-soup, soups for noodles (buck wheat noodle, wheat noodle, Chinese style wheat noodle, pasta and the like), seasonings such as Worcester sauce, soy sauce, dressing and the like.

The amount of the meat extract of the present invention to be added to the food or drink may be appropriately determined but it is preferable to add 0.3 to 4 percent by weight of the weight of the product and more preferable to add 0.5 to 2 percent by weight. The dilution ratio for diluting the meat extract to make soup is not specified but preferably 50 to 200.

Also, by adjusting a phosphate ion concentration, which is contained in the meat extract extracted from the material comprising livestock muscle or bone tissue, to 60 mmol/l or more, the growth of spore-forming bacteria in the meat extract can be suppressed as described above. It would be preferable for the phosphate ion concentration to be 60 to 500 mmol/l, and more preferably 70 to 200 mmol/l.

The examples of the present invention are described below.

### EXAMPLE 1

One hundred and fifty kg of dressed chicken meat (breast and thigh; hereinafter, referred to as chicken meat) and 350 kg of water were placed in a pressure cooker and heated at 98° C. for 8 hours for extraction. After the extraction, the cooker was left to cool naturally to 70° C., and the liquid portion was recovered from an outlet that was placed at the lower part of the cooker so that floating fat was not recovered with the liquid portion. The resulting liquid extract was concentrated using Evapor model CEP1 (manufactured by Okawara Manufacturing Co. Ltd.) to obtain 140 kg of clear chicken meat extract which contains 20 percent by weight of solid materials. The content of the solid material was measured by a Brix scale (ATAGO hand held refractometer, manufactured by ATAGO Co. Ltd.).

The phosphate ion concentration in the liquid extract from chicken meat was 182 mmol/l when measured with a capillary electrophoresis apparatus (HEWLETT PACKARD 3D CE, manufactured by Agilent Technologies) using Fusedsilica capillary (50 μm×104 cm, total length 112.5 cm) and Agilent Plating Bath Buffer, at capillary temperature of 15° C., with a negative voltage of 30 kV, at a measuring wave length of 350.20 nm (reference 230.10 nm).

The liquid extract from chicken meat was subjected to UHT sterilization at 130° C., 125° C. or 120° C. for 10 seconds each with a Small Volume Liquid Continuous Sterilization Test Machine model RMS (manufactured by Hisaka Works Co. Ltd.), and then poured into a 300 ml-volume aluminum pouch aseptically (hereinafter, referred to as chicken meat extracts 1 to 3, respectively). A pouch filled with chicken meat extract that did not undergo UHT sterilization was also prepared. This chicken meat extract is hereinafter, referred to as a control.

The chicken meat extracts 1 to 3 and the control were kept at room temperature for 24 hours and then subjected to the test according to the method described below to check the microorganisms in the extract.

One ml each of the chicken meat extracts 1 to 3 and the control were placed in each petri dishes aseptically, and 20 ml of nutrient agar medium (manufactured by Nissui Pharmaceutical Co.) which had been sterilized, melted and kept at 47° C. in advance, was added. The petri dish was rotated gently, and the medium was solidified by cooling. The petri dish was incubated at 50° C. for 5 days and the presence or absence of colonies in the agar medium was examined.

As the result, colonies were detected in the agar medium containing chicken meat extract 3 and the control but not in the agar medium containing chicken meat extracts 1 and 2.

The colonies detected on the agar medium containing chicken meat extract 3 and the control were picked up, and inoculated again on the nutrient agar medium and incubated at 50° C. for 48 hours. A heat resistance test was carried out on the cells forming these colonies by the method described below.

The colonies were picked up with a toothpick and suspended into 1 ml of sterilized water in a 1.5 ml-volume sample tube to prepare a cell suspension.

An observation of the cell suspension under a microscope revealed that most of the cells derived from control did not form spores and very few of them formed spores. On the other hand, all the cells derived from chicken meat extract 3 formed spores.

After heating the tubes containing cell suspension in a boiling water bath for 10 minutes, the cells were precipitated by centrifuging at 3000 G for 10 minutes, and the supernatant was removed. The precipitated cells were suspended in 1 ml of sterilized water, heated in a boiling water bath for 10 minutes, centrifuged at 3000 G for 10 minutes, and the supernatant was removed again. The resultant was suspended into 1 ml of sterilized water to prepare spore suspension.

Each of the spore suspensions (0.1 ml) was inoculated in the nutrient agar medium respectively and incubated at 50° C. for 48 hours.

As the results of the above observation under a microscope and the heat resistance test, it was determined that almost all of the microorganisms detected in the control were microorganisms other than spore-forming bacteria. However, the microorganisms detected in chicken meat extract 3 were spore-forming bacteria.

The spore-forming bacteria detected in the chicken meat extract 3 were identified by an API manual kit (commercial name: API-50CHB/CHB medium, API50CH, manufactured by Japan bioMerieux Co. Ltd.) according to the manufacturer's instruction. The result showed that the detected spore-forming bacteria were classified as Bacillus stearothermophilus, Bacillus coagulans, Bacillus subtilis and Bacillus brevis.

The chicken meat extracts 1 to 3 were kept at room temperature or at 50° C. for a month. No microorganisms were detected in the chicken meat extracts 1 to 3 kept at 50° C. or the chicken meat extracts 1 and 2 kept at room temperature. Spore-forming bacteria were detected in the chicken meat extract 3 kept at room temperature, and the number of the spore-forming bacteria therein was about the same as that found in the chicken meat extract 3 that had been kept at room temperature for 24 hours after packaging.

Bloating of the container due to gas or putrid smell was not observed in any of the chicken meat extracts 1 to 3 kept at room temperature or at 50° C.

On the other hand, a putrid smell was observed in the control after 24-hour storage.

The quality of the flavor was in the following order: chicken extract 3>chicken extract 2>chicken extract 1.

### EXAMPLE 2

Bacillus stearothermophilus was inoculated on a nutrient agar medium (manufactured by Nissui Pharmaceutical Co.) and incubated at 50° C. for 48 hours. After confirming the spore formation in the cell by an observation under a microscope, the cells were sterilized.

Cells picked up by a toothpick were suspended into 1 ml of sterilized water in a 1.5 ml-volume sample tube to prepare the cell suspension. A spore suspension was prepared from the cell suspension thus obtained according to the method described in Example 1. Then the spore concentration in the spore suspension was adjusted to 3×10⁴ to 3×10⁵ spore/ml. The bacteriostatic effect of the liquid extract was investigated using the spore suspension as described below.

About 140 kg of clear chicken bone extract containing 20 percent by weight of solid material was prepared according to the method described in Example 1, except that the Chicken bone carcass (90 percent by weight bone tissue, 10 percent by weight muscle tissue, hereinafter, referred to as chicken bone) was used as a material, and heating extraction was carried out at 115° C. for 1 hour.

This chicken bone extract and the chicken meat extract prepared in Example 1, which contains 182 mmol/l of phosphate ion, were mixed in various ratios to prepare liquid extract mixtures 1 to 9.

The phosphate ion concentrations in the chicken bone extract (test group 11) and the liquid extract mixtures 1 to 9 (test groups 2 to 10) were analyzed according to the method described in the Example 1.

The spore suspension described above was added to the chicken bone extract, the chicken meat extract prepared in Example 1 which contains 182 mmol/l of phosphate ion, and the liquid extract mixtures 1 to 9, so that the spore concentration was about 300 spore/ml to prepare spore-containing samples. The spore-containing samples were UHT sterilized using a Small Volume Liquid Continuous Sterilization Test Machine RMS type (manufactured by Hisaka Works Co. Ltd.) at 125° C. for 10 seconds and then poured into 300 ml-volume aluminum pouch aseptically to prepare packaged meat extracts.

After keeping the packaged meat extracts at 50° C. for 24 hours, 1 ml of the content and 1 ml of the solution prepared by diluting the content to 10 fold with sterilized water (hereinafter, referred to as 10 fold diluted sample; in the Example below the 10 fold diluted meat extract will also be referred to as 10 fold diluted sample) were put in plastic petri dishes, respectively, and 20 ml of nutrient agar medium (manufactured by Nissui Pharmaceutical Co.), which had been sterilized, melted and kept at 47° C., was added. The petri dish was rotated gently, and the medium were solidified by cooling.

The petri dishes were incubated at 50° C. for 5 days, and the number of colonies grown in the agar medium was count.

Results are Shown in Table 1.

The growth of spore-forming bacteria is evaluated as: +, when the colony count is more than 10,000 in the test group; +/−, when the colony count is 1,000-10,000 in the test group; and −, when the colony count is 1,000 or less in the test group. In the petri dishes with the 10 fold diluted samples, the colony counts were multiplied by 10 for evaluation.

TABLE 1

| | Ratio of chicken meat | | |
|---|---|---|---|
| | extract to chicken | | |
| | bone extract in the | | |
| | meat extract (Chicken | Phosphate ion | Growth of |
| | meat extract:Chicken | concentration | spore-forming |
| Test Group | bone extract) | (mmol/l) | bacteria |
| 1 | 10:0 | 182 | − |
| 2 | 9:1 | 164 | − |
| 3 | 8:2 | 146 | − |
| 4 | 7:3 | 128 | − |
| 5 | 6:4 | 111 | − |
| 6 | 5:5 | 94 | − |
| 7 | 4:6 | 76 | − |
| 8 | 3:7 | 58 | +/− |
| 9 | 2:8 | 40 | + |
| 10 | 1:9 | 22 | + |
| 11 | 0:10 | 8 | + |

As clearly shown in Table 1, the growth of Bacillus stearothermophilus was suppressed in the meat extracts containing phosphate ion at 76 mmol/l or more (test groups 1 to 7.)

### EXAMPLE 3

Disodium hydrogen phosphate was added to the chicken bone extract prepared in Example 2, which contains phosphate ion at 8 mmol/l, to bring up the phosphate ion concentration in the chicken bone extracts to 8 to 146 mmol/l. After adjusting the phosphate ion concentration, spore suspension of Bacillus stearothermophilus was added to these extracts according to the method described in Example 2, followed by UHT sterilization. The resultant was packaged (test groups 1 to 7).

The number of bacteria in the packaged meat extracts after incubating at 50° C. for 24 hours was counted according to the method described in Example 2.

Results are Shown in Table 2.

The growth of spore-forming bacteria is evaluated as: +, when the colony count is more than 10,000 in the test group; +/−, when the colony count is 1,000-10,000 in the test group; and −, when the colony count is 1,000 or less in the test group. In the petri dishes with the 10 fold diluted samples, the colony counts were multiplied by 10 for evaluation.

TABLE 2

| | Phosphate ion | Growth of |
|---|---|---|
| | concentration | spore-forming |
| Test Group | (mmol/l) | bacteria |
| 1 | 146 | − |
| 2 | 77 | − |
| 3 | 42 | +/− |
| 4 | 25 | + |
| 5 | 15 | + |
| 6 | 12 | + |
| 7 | 8 | + |

As clearly shown in Table 2, the growth of Bacillus stearothermophilus was suppressed in the meat extracts which was prepared to contain phosphate ion at 77 mmol/l or more (test groups 1 and 2).

### EXAMPLE 4

Instead of heat extracting using 150 kg of chicken meat and 350 kg of water by a pressure cooker, ten kg of pork loin (hereinafter, referred to as pork) and 15 kg of water were conducted to heat extracting at 98° C. for 6 hours using a vacuum hot kneader (Vacuum Reo-Kneader KHV, manufactured by Kajiwara Inc.). After letting the heated extract stand, the liquid extract was recovered so that no fat was recovered with the liquid extract, and the liquid extract was concentrated using Evapol type CEP1 (manufactured by Okawara Manufacturing Co. Ltd). A clear liquid extract containing 17 percent by weight of solid material was obtained.

The pork extract and the chicken bone extract prepared in Example 2 were mixed at ratios of 5:5 and 4:6 to prepare a mixture of liquid extracts.

The phosphate ion concentrations in the pork extract and the mixtures of liquid extract were analyzed according to the method described in Example 1.

Spores were added to the pork extract and the mixtures of the liquid extract according to the method described in Example 2, and subjected to UHT sterilization, followed by packaging the meat extracts (test groups 1 to 3).

The packaged meat extracts were kept at 50° C. for 24 hours, and then the numbers of bacteria in the meat extracts were counted according to the method described in Example 2.

Results are Shown in Table 3.

The growth of spore-forming bacteria is evaluated as: +, when the colony number is more than 10,000 in the test group; +/−, when the colony number is 1,000-10,000 in the test group; and −, when the colony number is 1,000 or less in the test group. In the petri dishes testing the 10 fold diluted samples, the colony numbers were multiplied by 10 for evaluation.

TABLE 3

| | Ratio of pork extract | | |
|---|---|---|---|
| | and chicken bone | | |
| | extract in the meat | | |
| | extract (pork | Phosphate ion | Growth of |
| | extract:chicken | concentration | spore-forming |
| Test Group | bone extract) | (mmol/l) | bacteria |
| 1 | 10:0 | 141 | − |
| 2 | 5:5 | 73 | − |
| 3 | 4:6 | 59 | + |

As clearly shown in Table 3, the growth of Bacillus stearothermophilus was suppressed in the meat extracts containing phosphate ion at 73 mmol/l or more (test groups 1 and 2).

### EXAMPLE 5

Instead of heat extracting using 150 kg of chicken meat and 350 kg of water by a pressure cooker, 5 kg of beef shoulder meat (hereinafter, referred to as beef) and 10 kg of water were conducted to heating in an open aluminum pot for 6 hours for an extraction. After the extraction, the fat layer was separated by standing at room temperature for 8 hours, and the lower layer was recovered. The lower layer was further treated with a separation funnel to recover liquid layer with no fat component to be mixed with it and a beef extract containing 18 percent by weight of solid material was prepared.

The beef extract and the chicken bone extract prepared in Example 2 were mixed at ratios of 4:6 and 3:7 to prepare a mixture of liquid extracts.

The phosphate ion concentrations in the beef extract and the mixtures of liquid extract were analyzed according to the method described in Example 1.

Spores were added to the beef extract and the mixtures of the liquid extract according to the method described in Example 2, and subjected to UHT sterilization, followed by packaging the meat extracts (test groups 1 to 3).

The packaged meat extracts were kept at 50° C. for 24 hours, and then the numbers of bacteria in the meat extracts were counted according to the method described in Example 2.

Results are Shown in Table 4.

The growth of spore-forming bacteria is evaluated as: +, when the colony count is more than 10,000 in the test group; +/−, when the colony count is 1,000-10,000 in the test group; and −, when the colony count is 1,000 or less in the test group. In the petri dishes testing the 10 fold diluted samples, the colony counts were multiplied by 10 for evaluation.

TABLE 4

| | Ratio of beef extract | | |
|---|---|---|---|
| | and chicken bone | | |
| | extract in the meat extract | Phosphate ion | Growth of |
| Test | (beef extract:chicken | concentration | spore-forming |
| Group | bone extract) | (mmol/l) | bacteria |
| 1 | 10:0 | 134 | − |
| 2 | 4:6 | 56 | − |
| 3 | 3:7 | 43 | + |

As clearly shown in Table 4, the growth of Bacillus stearothermophilus was suppressed in the meat extracts containing phosphate ion at 56 mmol/l or more (test groups 1 and 2).

### EXAMPLE 6

A soup was prepared by diluting meat extract 100 fold with hot water and then adding salt to a final concentration of 0.4 percent by weight, wherein the meat extract was obtained by UHT sterilizing and packaging the chicken bone extract prepared in Example 2. This soup was used as a control.

Furthermore, a meat extract, in which phosphate ion concentration was adjusted to 500 mmol/l by adding disodium hydrogen phosphate aseptically, was prepared and a soup was prepared from this meat extract according to the method described above. This soup was used as a phosphate-added group.

The flavors of the meat extracts in these soups were evaluated by organoleptic test. The organoleptic test was carried out by a panel of 6 experienced experts using a 7 point-scale with the control being 3.5.

Results showed that the flavor of the meat extract in the phosphate-added group scored 3.8 (+/−0.36) indicating that the meat extract retained a good flavor.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

1. A meat extract in which no microorganisms other than spore-forming bacteria are detectable and 60 mmol/l or more of phosphate ion is contained.

2. A meat extract according to claim 1 wherein the spore-forming bacteria are selected from a group of microorganisms belonging to the genus Bacillus, Sporolactobacillus, Clostridium or Sporosarcina.

3. A meat extract according to claim 1 wherein the microorganism belonging to the genus Bacillus is a microorganism belonging to Bacillus stearothermophilus.

4. A meat extract according to claim 1, wherein the meat extract is a meat extract extracted from materials comprising muscle tissues or bone tissues of livestock.

5. A meat extract according to claim 4 wherein the livestock is poultry.

6. A process for producing a meat extract comprising:
preparing a liquid extract from a material comprising muscle tissues or bone tissues of livestock;
adjusting the phosphate ion concentration of the liquid extract to 60 mmol/l or more;
and then sterilizing at ultra-high temperature (UHT sterilization).

7. A process for producing a meat extract comprising:
preparing a liquid extract from a material comprising muscle tissues or bone tissues of livestock;
sterilizing the liquid extract by UHT sterilization; and then adjusting the phosphate ion concentration of the liquid extract to 60 mmol/l or more.

8. A process for producing a meat extract according to claim 6 wherein the material comprising muscle tissues or bone tissues contains 150 parts by weight or less of bone tissues to 100 parts by weight of muscle tissues.

9. A process according to claim 6 wherein the UHT sterilization is conducted at 120 to 130° C.

10. A process according to claim 6 wherein the UHT sterilization is conducted for 5 to 15 seconds.

11. A process according to claim 6 wherein the livestock is poultry.

12. A method of suppressing growth of spore-forming bacteria in a meat extract, comprising:
adjusting a phosphate ion concentration in the meat extract extracted from a material comprising muscle tissues and bone tissues of livestock to 60 mmol/l or more.

13. A method according to claim 12 wherein the livestock is poultry.
